(19) United States
(12) Patent Application Publication
(10) Pub. No.: US 2024/0242069 A1
(43) Pub. Date: Jul. 18, 2024

(54) SYSTEM AND METHOD FOR RECOMMENDING ITEMS BASED ON ENHANCED USER REPRESENTATIONS

(71) Applicant: Walmart Apollo, LLC, Bentonville, AR (US)

(72) Inventors: Aysenur Inan, Mountain View, CA (US); Reza Yousefi Maragheh, Santa Clara, CA (US); Jianpeng Xu, Cupertino, CA (US); Hyun Duk Cho, San Francisco, CA (US); Sushant Kumar, San Jose, CA (US); Kannan Achan, Saratoga, CA (US)

(21) Appl. No.: 18/153,796

(22) Filed: Jan. 12, 2023

(51) Int. Cl. G06N 3/08; G06Q 30/0601

(52) U.S. Cl. CPC G06N 3/08; G06Q 30/0631

(57) ABSTRACT

Systems and methods for recommending items based on enhanced user representations are disclosed. A sparse part and a dense part of user-item interaction data are generated. While the dense part is split into a plurality of training data batches, the sparse part is split into a plurality of inference data batches. A deep learning model is trained based on the plurality of training data batches. Inferred user embeddings are generated by applying the trained deep learning model to the plurality of inference data batches in parallel. The inferred user embeddings are non-zero user representations in a same latent space. Based on user session data of a query user and the inferred user embeddings, recommended items are generated and transmitted to a user device for display to the query user.

### TECHNICAL FIELD

This application relates generally to item recommendations and, more particularly, to systems and methods for providing item recommendations based on enhanced user representations.

### BACKGROUND

Item recommendation tasks in e-commerce industry are essential to improve user experiences by recommending items to users. Conventional recommendation systems provide information about matches between users (e.g., shopping customers) and items (e.g., books, electronics, grocery) based on user interests, user preferences, or historical interactions.

Deriving user or customer representations is an important task as it would improve quality of recommendations and drive engagement and revenue. Current customer understanding models use historical data to make predictions or estimations about customers' affinities. But given a huge number of items offered for purchase by a retailer, each customer does not interact (e.g., purchase, click, view, access) with most of the items, which provides a sparse dataset of user-item interactions. A traditional machine learning model has poor performance on sparse datasets, and fails to capture non-linear relationships between users and items. In addition, a traditional machine learning technique requires extracting features manually before training the model.

Hence, it is challenging yet desirable to generate accurate user representations based on sparse user-item interaction data, to improve item recommendation quality.

### SUMMARY

The embodiments described herein are directed to systems and methods for providing item recommendations based on enhanced user representations.

In various embodiments, a system including a database and at least one processor operatively coupled to the database is disclosed. The at least one processor is configured to: obtain user-item interaction data with respect to a plurality of users, generate a sparse part of the user-item interaction data, wherein a majority of the sparse part are zero elements, generate a dense part of the user-item interaction data based on the sparse part, wherein a majority of the dense part are non-zero elements, split the dense part of the user-item interaction data into a plurality of training data batches, split the sparse part of the user-item interaction data into a plurality of inference data batches, train a deep learning model based on the plurality of training data batches to generate a trained deep learning model, generate inferred user embeddings by applying the trained deep learning model to the plurality of inference data batches in parallel, wherein the inferred user embeddings are non-zero user representations in a same latent space, obtain user session data from a user device of a query user, generate recommended items based on the user session data and the inferred user embeddings, and transmit information about the recommended items to the user device for display to the query user.

In various embodiments, a computer-implemented method is disclosed. The computer-implemented method includes steps of: obtaining user-item interaction data with respect to a plurality of users; generating a sparse part of the user-item interaction data, wherein a majority of the sparse part are zero elements; generating a dense part of the user-item interaction data based on the sparse part, wherein a majority of the dense part are non-zero elements; splitting the dense part of the user-item interaction data into a plurality of training data batches; splitting the sparse part of the user-item interaction data into a plurality of inference data batches; training a deep learning model based on the plurality of training data batches to generate a trained deep learning model; generating inferred user embeddings by applying the trained deep learning model to the plurality of inference data batches in parallel, wherein the inferred user embeddings are non-zero user representations in a same latent space; obtaining user session data from a user device of a query user; generating recommended items based on the user session data and the inferred user embeddings; and transmitting information about the recommended items to the user device for display to the query user.

In various embodiments, a non-transitory computer readable medium having instructions stored thereon is disclosed. The instructions, when executed by at least one processor, cause at least one device to perform operations including: obtaining user-item interaction data with respect to a plurality of users; generating a sparse part of the user-item interaction data, wherein a majority of the sparse part are zero elements; generating a dense part of the user-item interaction data based on the sparse part, wherein a majority of the dense part are non-zero elements; splitting the dense part of the user-item interaction data into a plurality of training data batches; splitting the sparse part of the user-item interaction data into a plurality of inference data batches; training a deep learning model based on the plurality of training data batches to generate a trained deep learning model; generating inferred user embeddings by applying the trained deep learning model to the plurality of inference data batches in parallel, wherein the inferred user embeddings are non-zero user representations in a same latent space; obtaining user session data from a user device of a query user; generating recommended items based on the user session data and the inferred user embeddings; and transmitting information about the recommended items to the user device for display to the query user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide item recommendations based on enhanced user representations, in accordance with some embodiments of the present teaching.

FIG. 2 illustrates a computer system configured to implement one or more processes to provide item recommendations based on enhanced user representations, in accordance with some embodiments of the present teaching.

FIG. 3 is a block diagram illustrating various portions of a system including a database for providing item recommendations based on enhanced user representations, in accordance with some embodiments of the present teaching.

FIG. 4 illustrates an exemplary user-item interaction matrix, in accordance with some embodiments of the present teaching.

FIG. 5 illustrates an exemplary eco-system for providing item recommendations based on enhanced user representations, in accordance with some embodiments of the present teaching.

FIG. 6 illustrates an exemplary process for generating large scale user representations, in accordance with some embodiments of the present teaching.

FIG. 7 illustrates an exemplary deep learning architecture utilized for generating large scale user representation, in accordance with some embodiments of the present teaching.

FIG. 8 is a flowchart illustrating an exemplary method for providing item recommendations based on enhanced user representations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

In e-commerce, deriving user or customer representations is an important task as it would improve quality of recommendations and drive engagement and revenue. While a training data based on user-item interactions is often very sparse, e.g. with many missing data filled with zero, a traditional machine learning model is not a good choice to generate user representations. While a deep learning model can be utilized to extract features during training and capture non-linear relationships between users and items, it requires massive data and high resources in order to get a meaningful representation. When there is huge amount of data processed, scalability is a major issue. In addition, the training and prediction (or inference) time might be long, which disables the system to update user representations frequently.

One goal of various embodiments in the present teaching is to generate large scale customer representations in a latent space to be used in downstream applications, based on a correct, scalable and repeatable generation process of a system. The process for generating large scale customer representations should be correct and accurate by, e.g. integrating meaningful customer signals, capturing higher order information than previous iterations to mirror layered customer understanding. The process for generating large scale customer representations should be scalable, e.g. being able to scale at least to millions of customers over millions of items. The process for generating large scale customer representations should be repeatable, e.g. easy to produce or re-produce such that the customer representations can be refreshed multiple times a week, within a reasonable computing time.

In some embodiments, the system can enhance customer experience using latent space representations and attributes to surface relevant recommendations, based on a scalable deep learning architecture (SDLA). The SDLA allows the system to run deep learning models in a fast and efficient manner to capture customers' latest actions to bring up better representations. In addition, SDLA helps the system to use current resources in a more efficient way, which results in both higher coverage and better representation of customers in a short amount of time, even when the training data is very sparse and misses a majority of the user-item interaction data.

Furthermore, in the following, various embodiments are described with respect to methods and systems for recommending items based on enhanced user representations. In some embodiments, a sparse part and a dense part of user-item interaction data are generated. While the dense part is split into a plurality of training data batches, the sparse part is split into a plurality of inference data batches. A deep learning model is trained based on the plurality of training data batches. Inferred user embeddings are generated by applying the trained deep learning model to the plurality of inference data batches in parallel. The inferred user embeddings are non-zero user representations in a same latent space. Based on user session data of a query user and the inferred user embeddings, recommended items are generated and transmitted to a user device for display to the query user.

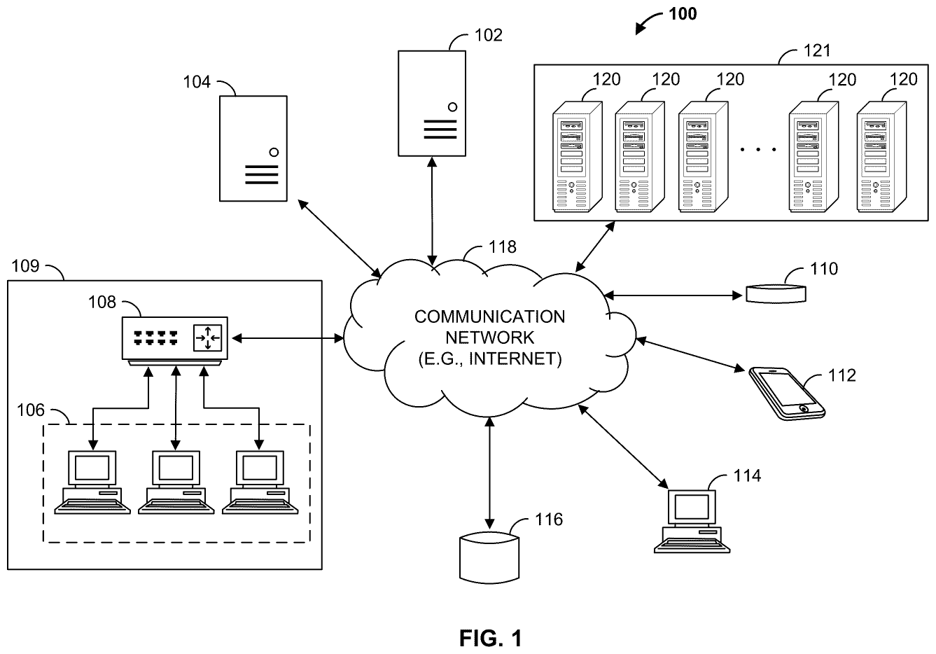

Turning to the drawings, FIG. 1 is a network environment 100 configured to provide item recommendations based on enhanced user representations, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The item recommendation computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the item recommendation computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to item recommendation computing device 102.

Although FIG. 1 illustrates three customer computing devices 110, 112, 114, the network environment 100 can include any number of customer computing devices 110, 112, 114. Similarly, the network environment 100 can include any number of the item recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, second customer computing device 112, and Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of customer computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the item recommendation computing device 102 over communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the item recommendation computing device 102.

In some examples, the item recommendation computing device 102 may execute one or more models (e.g., algorithms), such as a machine learning model, deep learning model, statistical model, etc., to determine recommended items to advertise to the customer (i.e., item recommendations). The item recommendation computing device 102 may transmit the item recommendations to the web server 104 over the communication network 118, and the web server 104 may display advertisements for one or more of the recommended items on the website to the customer. For example, the web server 104 may display the recommended items to the customer on a homepage, a catalog webpage, an item webpage, or a search results webpage of the website (e.g., as the customer browses those respective webpages).

In some examples, the web server 104 transmits a recommendation request to the item recommendation computing device 102. The recommendation request may be sent together with a search query provided by the customer (e.g., via a search bar of the web browser), or a standalone recommendation query provided by a processing unit in response to the user adding one or more items to cart or interacting (e.g., engaging, clicking, or viewing) with one or more items.

In one example, a customer selects an item on a website hosted by the web server 104, e.g. by clicking on the item to view its product description details, by adding it to shopping cart, or by purchasing it. The web server 104 may treat the item as an anchor item or query item for the customer, and send a recommendation request to the item recommendation computing device 102. In response to receiving the request, the item recommendation computing device 102 may execute the one or more processors to determine recommended items that are related (e.g. substitute or complementary) to the anchor item, and transmit the recommended items to the web server 104 to be displayed together with the anchor item to the customer.

In another example, a customer submits a search query on a website hosted by the web server 104, e.g. by entering a query in a search bar. The web server 104 may send a recommendation request to the item recommendation computing device 102. In response to receiving the request, the item recommendation computing device 102 may execute the one or more processors to first determine search results including items matching the search query, and then determine recommended items that are related to one or more top items in the search results. The item recommendation computing device 102 may transmit the recommended items to the web server 104 to be displayed together with the search results to the customer.

In either of the above examples, the item recommendation computing device 102 may determine a customer representation for the customer, e.g. based on latent space embeddings using a scalable deep learning architecture. The customer representation can indicate the customer's affinity to certain kinds of the items. Based on the customer representation, the recommended items may be ordered to generate a ranked list of recommended items, where a higher rank means the corresponding recommended item is more likely to interest the customer for further interactions.

The item recommendation computing device 102 may transmit the ranked list of recommended items to the web server 104 over the communication network 118. The web server 104 may display the ranked list of recommended items on a search results webpage, or on a product description webpage regarding an anchor item.

The item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store purchase data received from the web server 104 in the database 116. The item recommendation computing device 102 may also receive from the web server 104 user session data identifying events associated with browsing sessions, and may store the user session data in the database 116.

In some examples, the item recommendation computing device 102 generates training data for a plurality of models (e.g., machine learning models, deep learning models, statistical models, algorithms, etc.) based on historical user session data, purchase data, and current user session data for the users. The item recommendation computing device 102 trains the models based on their corresponding training data, and the item recommendation computing device 102 stores the models in a database, such as in the database 116 (e.g., a cloud storage).

The models, when executed by the item recommendation computing device 102, allow the item recommendation computing device 102 to determine item recommendations for one or more items to advertise to a customer. For example, the item recommendation computing device 102 may obtain the models from the database 116. The item recommendation computing device 102 may then receive, in real-time from the web server 104, current user session data identifying real-time events of the customer interacting with a website (e.g., during a browsing session). In response to receiving the user session data, the item recommendation computing device 102 may execute the models to determine item recommendations for items to display to the customer.

In some examples, the item recommendation computing device 102 receives current user session data from the web server 104. The user session data may identify actions (e.g., activity) of the customer on a website. For example, the user session data may identify item impressions, item clicks, items added to an online shopping cart, conversions, click-through rates, advertisements viewed, and/or advertisements clicked during an ongoing browsing session (e.g., the user data identifies real-time events).

In some examples, the item recommendation computing device 102 may train a deep learning model to generate user representations in a latent space, based on user-item interaction data of a plurality of customers. The user-item interaction data may be stored in the database 116, another database coupled to the network 118, or locally at the item recommendation computing device 102. The item recommendation computing device 102 may generate a sparse part of the user-item interaction data, where a majority of the sparse part are zero elements, and generate a dense part of the user-item interaction data based on the sparse part, where a majority of the dense part are non-zero elements. In some embodiments, the item recommendation computing device 102 can split the dense part of the user-item interaction data into a plurality of training data batches, and split the sparse part of the user-item interaction data into a plurality of inference data batches.

The item recommendation computing device 102 can train the deep learning model based on the plurality of training data batches to generate a trained deep learning model with some model weights. The trained deep learning model and the model weights may be stored in the database 116 or a cloud database coupled to the network 118. The cloud-based engine 121 may generate inferred user embeddings by applying the trained deep learning model with the model weights to the plurality of inference data batches. For example, each inference data batch may correspond to a different one of the processing devices 120, such that each processing device 120 can run in parallel a full replica of the trained deep learning model with the model weights on the corresponding inference data batch, to generate inferred user embeddings in the same latent space. As such, enhanced user representations with non-sparse embeddings can be generated for the plurality of users.

In some examples, the correspondence between the processing devices 120 and the inference data batches may be based on an assignment by the item recommendation computing device 102. For example, each inference data batch may be assigned to a virtual machine hosted by a processing device 120. The virtual machine may cause the embedding inference process to execute on one or more processing units such as GPUs.

Based on the output of the models, the item recommendation computing device 102 may generate ranked item recommendations for items to be displayed on the website, in response to user session data obtained from a user device of a query user. The query user may or may not be a user among the plurality of users whose interaction data were used for training. In some examples, the item recommendation computing device 102 can generate recommended items based on the user session data of the user and an inferred user representation embedding for the user. For example, the item recommendation computing device 102 may transmit the ranked item recommendations to the web server 104, and the web server 104 may display the ranked recommended items to the query user together with an anchor item selected by the query user.

Among other advantages, the disclosed embodiments allow for accurately and frequently predicting users' preferences based on a scalable deep learning architecture, which helps the disclosed system to work with massive amount of data using less resources in a fast and robust manner. The system can rapidly predict users' preferences and can reflect latest users' representational changes, while improving coverage of user representations.

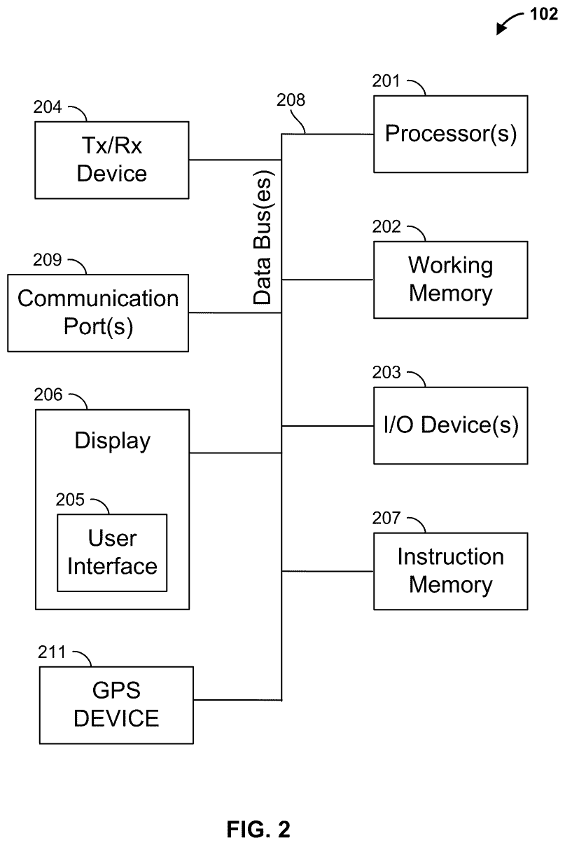

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the item recommendation computing device 102. It should be appreciated, however, that the elements described can be included, as applicable, in any of the item recommendation computing device 102, the web server 104, the workstation(s) 106, the multiple customer computing devices 110, 112, 114, and the one or more processing devices 120.

As shown in FIG. 2, the item recommendation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the item recommendation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the item recommendation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the item recommendation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the item recommendation computing device 102 may determine a local geographical area (e.g., town, city, state, etc.) of its position. Based on the geographical area, the item recommendation computing device 102 may determine relevant trend data (e.g., trend data identifying events in the geographical area).

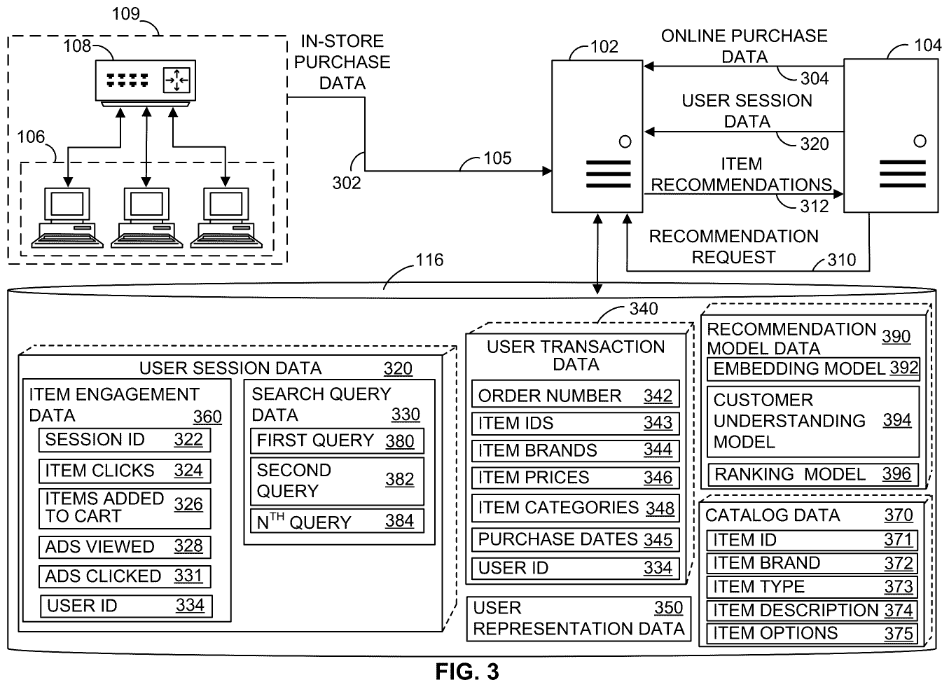

FIG. 3 is a block diagram illustrating various portions of a system including a database, e.g. the database 116 of FIG. 1, for providing item recommendations based on enhanced user representations, in accordance with some embodiments of the present teaching. As indicated in FIG. 3, the item recommendation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In this example, the user session data 320 may include item engagement data 360 and/or search query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.).

The search query data 330 may identify one or more searches conducted by a user during a browsing session (e.g., a current browsing session). For example, the item recommendation computing device 102 may receive a recommendation request 310 from the web server 104, where the recommendation request 310 may be associated with a search request that identifies one or more search terms provided by the user. The item recommendation computing device 102 may store the search terms as provided by the user as search query data 330. In this example, the search query data 330 includes first query 380, second query 382, and Nth query 384.

The item recommendation computing device 102 may also receive online purchase data 304 from the web server 104, which identifies and characterizes one or more online purchases, such as purchases made by the user and other users via a retailer's website hosted by the web server 104. The item recommendation computing device 102 may also receive in-store purchase data 302 from the store 109, which identifies and characterizes one or more in-store purchases.

The item recommendation computing device 102 may parse the in-store purchase data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item types 348 identifying a type (e.g., category) of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store recommendation model data 390 identifying and characterizing one or more machine learning models. For example, the recommendation model data 390 may include an embedding model 392, a customer understanding model 394, and a ranking model 396. Each of the embedding model 392, the customer understanding model 394 and the ranking model 396 may be a machine learning model trained based on user-item interaction data generated by the item recommendation computing device 102. In various embodiments, the user-item interaction data may include or be derived from one or more of: the user session data 320, the user transaction data 340, and the catalog data 370.

In some examples, the database 116 may further store user representation data 350. The user representation data 350 may include user embeddings in a latent space, where each user embedding represents a respective user's interests in various items offered for purchase by the retailer operating the web server 104 and the store 109. In some embodiments, each user embedding is inferred based on the respective user's interaction (e.g. click, purchase, view, etc.) with items, and/or based on applying the embedding model 392, which may be a trained deep learning model generated based on user-item interaction data of many different users of the retailer.

In some examples, the item recommendation computing device 102 may train the customer understanding model 394 based on the user representation data 350, and store a trained customer understanding model 394 in the database 116. The item recommendation computing device 102 may also generate the ranking model 396 based on the trained customer understanding model 394, and store the ranking model 396 in the database 116. In various embodiments, the database 116 may either be a single database (e.g. a cloud database) or include many databases located at different locations respectively. In various embodiments, the item recommendation computing device 102 may re-train and update one or more of the embedding model 392, the customer understanding model 394 and the ranking model 396, based on updated user-item interaction data, e.g. once per day, twice per day, once per week, or twice per week, and store the updated models in the database 116.

In some examples, the item recommendation computing device 102 receives (e.g., in real-time) the user session data 320 for a customer interacting with a website hosted by the web server 104. In response, the item recommendation computing device 102 generates item recommendation 312 identifying recommended items to advertise to the customer, and transmits the item recommendation 312 to the web server 104.

In some examples, the recommendation request 310 may be associated with an anchor item or query item to be displayed to a user, e.g. after the user chooses the anchor item from a search results webpage, or after the user clicks on an advertisement or promotion related to the anchor item. In response, the item recommendation computing device 102 generates recommended items that are related (e.g. similar, substitute or complementary) to the anchor item. Then, the item recommendation computing device 102 may provide a ranking of the recommended items based on the customer understanding model 394 and/or the ranking model 396, and transmit the top K recommended items as the ranked item recommendation 312 to the web server 104 for displaying the top K recommended items together with the anchor item to the user, where K may be a predetermined positive integer.

In some embodiments, the item recommendation computing device 102 may assign each of the embedding model 392, the customer understanding model 394 and the ranking model 396 (or parts thereof) to a different processing unit or virtual machine hosted by one or more processing devices 120. Further, the item recommendation computing device 102 may obtain the outputs of the embedding model 392, the customer understanding model 394 and/or the ranking model 396 from the processing units, and generate the ranked item recommendation 312 based on the outputs of the models.

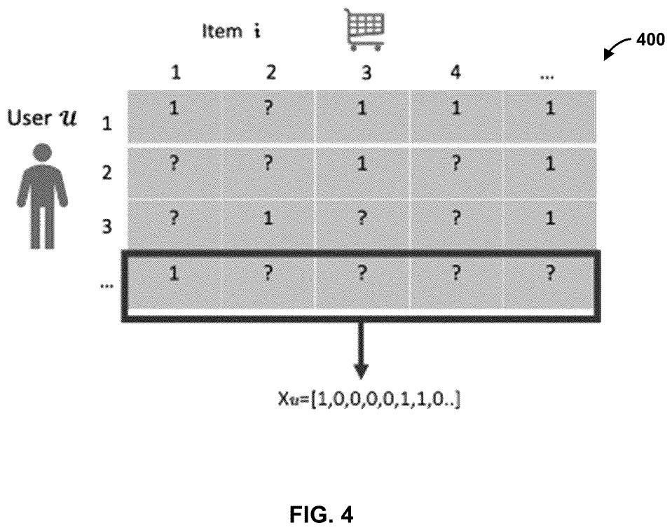

FIG. 4 illustrates an exemplary user-item interaction matrix 400, in accordance with some embodiments of the present teaching. The user-item interaction matrix 400 is an exemplary form to carry user-item interaction data, which may include some implicit user feedback data like browsing history, purchase history, etc. Each row of the user-item interaction matrix 400 represents a user u, and each column of the user-item interaction matrix 400 represents an item i. An element at row u and column i in the user-item interaction matrix 400 represents whether user u has interacted with item i, where the element is equal to I when user u has interacted with item i.

As shown in FIG. 4, there are lots of elements missing data (marked “?”) in the user-item interaction matrix 400, which means there is no interaction between the corresponding user and the corresponding item. This is because there is usually a huge number (e.g. millions) of items sold by a retailer, e.g. Walmart, and a customer does not interact with most of those items. This kind of matrix with many missing data (e.g. a majority of the elements in the user-item interaction matrix 400 are marked “?”) is called a sparse matrix, where the dataset represented by the matrix is called a sparse dataset. When deriving a user vector representation Xu for user u, the initial values for the missing data are filled with zeros, e.g. Xu={1, 0, 0, 0, 0, 1, 1, 0 . . . }. The user vector representation Xu is trying to predict or estimate interests of user u regarding different items. Because the user vector representation Xu generated in this manner includes many zeros (e.g. a majority of the elements in Xu are zeros), the user vector representation Xu is very sparse and is not proper to be used directly for item recommendation. One goal of the disclosed system is to embed the missing data in the user-item interaction matrix 400, e.g. using the embedding model 392 trained based on deep learning, to generate inferred user representations that are embedded with non-zero elements. In some embodiments, the non-zero elements are between 0 and 1.

In some embodiments, the inferred user representations are all user embeddings in a same latent space. In some embodiments, each inferred user representation may include values representing more than user-item interactions, e.g. values representing an attribute of the user, a brand loyalty of the user, an engagement level of the user, etc. In some embodiments, the inferred user representations may capture not only user-item relationships, but also item-item relationships and/or user-user relationships, which can also be derived from the user session data and user transaction data of different users. In some embodiments, the inferred user representations may include values representing more than user-item interactions, e.g. values representing an attribute of the user, a brand loyalty of the user, an engagement level of the user, etc.

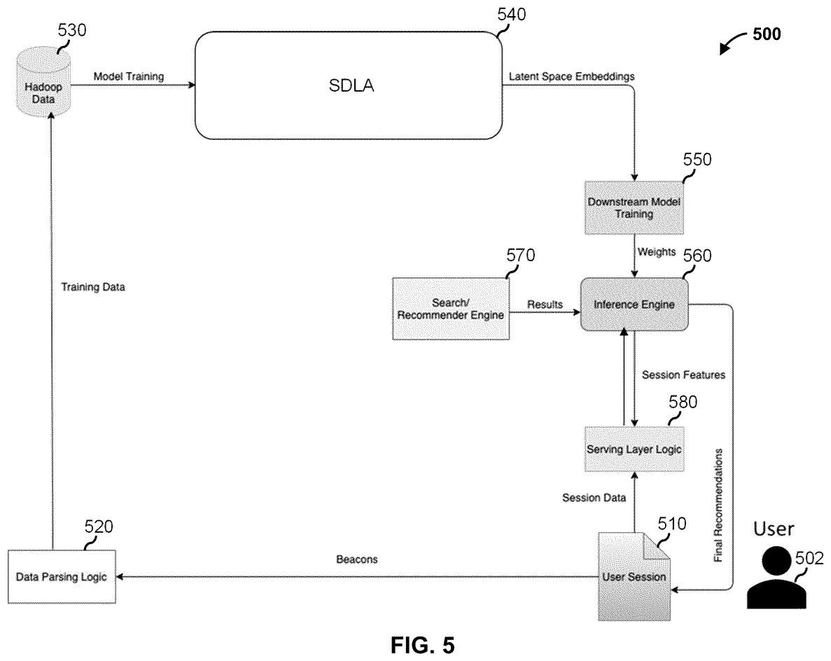

FIG. 5 illustrates an exemplary eco-system 500 for providing item recommendations based on enhanced user representations, in accordance with some embodiments of the present teaching. As shown in FIG. 5, each user of a website, e.g. the user 502 of a website hosted by the web server 104 in FIG. 1, can log in (or just access with a temporary ID) the website and generate a user session data 510.

As shown in FIG. 5, the eco-system 500 includes a data parsing logic 520 that is configured to obtain the user session data 510, e.g. via beacon signals, and generate some training data for training a scalable deep learning architecture (SDLA) 540. In various embodiments, the data parsing logic 520 may be implemented by the web server 104 in FIG. 1. The data parsing logic 520 may parse all user session data of all users accessing the website during a historical period, e.g. the past year, and generate user-item interaction data as the training data to be stored in a Hadoop database 530. In various embodiments, the Hadoop database 530 may be implemented as a part of the database 116 in FIG. 1, or as another database coupled to the network 118 in FIG. 1.

During a model training process, the SDLA 540 can retrieve the training data from the Hadoop database 530 and generate a trained deep learning model with inferred latent space embeddings in a same latent space, where each latent space embedding represents a user's interest to different items of the website. While the user-item interaction data in the training data may be very sparse with many missing data, the inferred latent space embeddings can include mostly non-zero elements inferred by the trained deep learning model.

Based on the inferred latent space user embeddings, one or more downstream models can be trained by the downstream model training module 550. In some examples, a customer understanding model can be trained by the downstream model training module 550 based on the inferred latent space user embeddings, to determine factors and weights to derive a user's affinity to towards a brand, a product type, a price range, and/or a product feature. In some examples, a ranking model can be trained by the downstream model training module 550 based on the inferred latent space user embeddings, to determine factors and weights to rank recommended items to be displayed to a user. In some embodiments, each of the SDLA 540 and the downstream model training module 550 may be implemented by the item recommendation computing device 102 and/or the cloud-based engine 121 in FIG. 1.

As shown in FIG. 5, the eco-system 500 also includes a search/recommender engine 570 that can generate results of a search operation or recommendation operation, in response to a search request or recommendation request triggered by a user, e.g., the user 502. The search/recommendation results can be sent to an inference engine 560, which can generate a final ranked list of recommended items to be presented to the user 502 in response to the search or recommendation request. For example, the final ranked list of recommended items may be displayed on a user device of the user 502, where the user session data 510 is also generated from the user device. In some embodiments, each of the search/recommender engine 570 and the inference engine 560 may be implemented by the item recommendation computing device 102 and/or the web server 104 in FIG. 1.

In some embodiments, the inference engine 560 may send some session features to a serving layer logic 580 that may be implemented by the web server 104 in FIG. 1. These session features may be generated based on the embedded user representations created by the SDLA 540 and/or the downstream models generated by the downstream model training module 550. The serving layer logic 580 can obtain and analyze the user session data 510 and generate personalized session features (e.g. in form of a personal profile) for the user 502, based on the session features obtained from the inference engine 560.

In some embodiments, the serving layer logic 580 may forward the personalized session features to the inference engine 560, such that the inference engine 560 can generate the final ranked list of the recommended items based on both the trained downstream machine learning model(s) and the personalized session features with respect to the user 502. While the final ranked list of the recommended items is displayed to the user 502, more data may be collected via the user session data 510 based on interactions between the user 502 and the final ranked list of the recommended items to generate an updated user session 510. As such, the models, the user representations, and/or the recommended items as discussed above in FIG. 5 can be updated accordingly.

In a practical example, the user 502 may have accessed a retailer's website and clicked on a laptop of brand D, to view a detailed web page about the laptop of brand D. The search/recommender engine 570 may recommend items similar to the laptop of brand D, e.g. other laptops of brand D and other brands. Without an accurate user representation for the user 502, the search/recommender engine 570 may determine to rank laptops of brand D higher than other laptops in the recommended items when displaying the recommended items to the user 502.

But in this example shown in FIG. 5, the downstream model training module 550 may train a customer brand understanding model based on the user embeddings generated using the SDLA 540. As such, the inference engine 560 can better understand the interests of the user 502 with full and accurate user representation data generated by the SDLA 540. For example, the inference engine 560 may determine or predict, based on the customer brand understanding model and the personalized features from the user session data 510 of the user 502, that the user 502 has a high affinity towards brand L. Accordingly, the inference engine 560 may put some laptops of brand L on the very top of the ranked list of final recommended items, when displaying the final recommended items to the user 502.

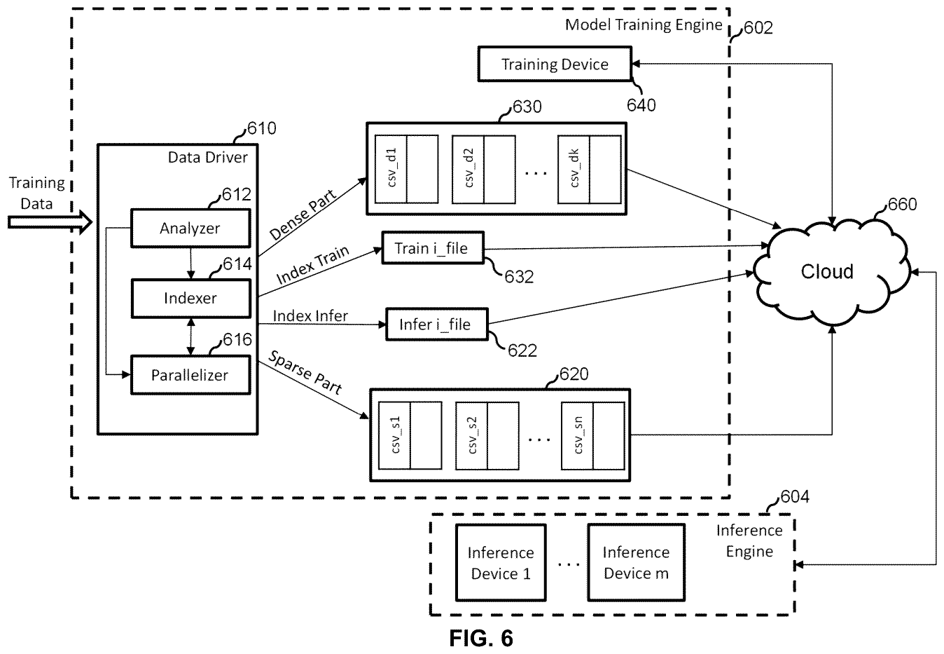

FIG. 6 illustrates an exemplary process for generating large scale user representations, in accordance with some embodiments of the present teaching. As shown in FIG. 6, the process is performed by a model training engine 602 and an inference engine 604.

In some embodiments, the model training engine 602 may be part of the SDLA 540 in FIG. 5 and/or can be implemented by the item recommendation computing device 102 in FIG. 1. As shown in FIG. 6, the model training engine 602 includes a data driver 610 that is configured to obtain training data for training a deep learning model. In some embodiments, the training data may be obtained from the Hadoop database 530 in FIG. 5 or the database 116 in FIG. 1. In some embodiments, the training data may include user-item interaction data of different users of a retailer (e.g. via the retailer's website or stores) during a past period of time. In some embodiments, the user-item interaction data may be generated by parsing historical user session data and historical user transaction data of the different users. In some embodiments, the user-item interaction data may include many user-item interaction matrices that are sparse matrices like the user-item interaction matrix 400 in FIG. 4.

In some embodiments, the user-item interaction data includes a user-item interaction matrix, where each element in the user-item interaction matrix is either 1 representing a corresponding user had an interaction with a corresponding item, or 0 representing a corresponding user had no interaction with a corresponding item. While there are tons of items sold by the retailer, a majority of the elements in the user-item interaction matrix are 0, meaning most users do not interact with most of the items.

As shown in FIG. 6, the data driver 610 includes an analyzer 612 that is configured to analyze the training data and determine some configurations for training, e.g. duration of input features, product types, brands, etc. The data driver 610 also includes an indexer 614 that is configured to generate indexes for the customers and the items to maintain a global mapping. While each customer has a corresponding customer ID that can be hashed during the training, an index for the customer can help tracking the customer before and after the deep learning model training. Similarly, while each item has a corresponding item ID that can be hashed during the training, an index for the item can help tracking the item before and after the deep learning model training.

As shown in FIG. 6, the data driver 610 also includes a parallelizer 616 that is configured to split the training data into different batches. For example, the parallelizer 616 can generate a sparse part of the training data, wherein a majority of the sparse part are zero elements, and split the sparse part of the training data into a plurality of inference data batches 620. In addition, the parallelizer 616 can also generate a dense part of the training data based on the sparse part, wherein a majority of the dense part are non-zero elements, and split the dense part of the training data into a plurality of training data batches 630. In this example, each of the inference data batches 620 and the training data batches 630 is a csv file. In other embodiments, the inference data batches 620 and the training data batches 630 can be files in a different format. The plurality of training data batches 630 and the plurality of inference data batches 620 may be stored into a cloud database 660. In some embodiments, the cloud database 660 may be the database 116 in FIG. 1, or another cloud database coupled to the network 118 in FIG. 1.

The indexer 614 may generate training indexes 632 with respect to the plurality of training data batches 630; and generate inference indexes 622 with respect to the plurality of inference data batches 620. The training indexes 632 and the inference indexes 622 may be stored into the cloud database 660. As such, the data driver 610 transforms input features of the training data to a form that is consumable by the deep learning model.

As shown in FIG. 6, the model training engine 602 also includes a training device 640 that is configured to train the deep learning model based on the plurality of training data batches 630 and the training indexes 632 to generate a plurality of model weights. Because the plurality of training data batches 630 are generated from a dense part of the training data, not many zero or missing data are included. As such, the plurality of training data batches 630 form a good dataset for training. In some embodiments, the training device 640 may be implemented by the processing devices 120 in FIG. 1, such that each of the training data batches 630 may be sent to a respective one of the processing devices 120 for training. In some embodiments, the trained deep learning model and the plurality of model weights are stored in the cloud database 660.

As shown in FIG. 6, the inference engine 604 comprises a plurality of inference devices. In some embodiments, each of the inference devices corresponds to a respective inference data batch of the plurality of inference data batches 620 according to the inference indexes 622. Each of the inference devices in the inference engine 604 is configured to generate inferred user embeddings by applying a full replica of the trained deep learning model with the plurality of model weights to the respective inference data batch. The inference engine 604 may store the inferred user embeddings as user presentations into the cloud database 660. In some embodiments, the inferred user embeddings generated by the inference engine 604 from the sparse part and the user representations in the dense part can together form an updated set of user representations in a latent space, to be utilized by any downstream model, e.g. for item recommendations. In some embodiments, the inference engine 604 may be part of the SDLA 540 in FIG. 5 and/or can be implemented by the cloud-based engine 121 in FIG. 1.

As such, the disclosed SDLA, as shown in FIG. 6, can include two layered architectures: a training stack performed by the model training engine 602 and an inferencing stack performed by the inference engine 604. The training stack can be used to train the deep learning model from the dense part of the interaction data to get model weights, and store them to predict or estimate on the sparse part of the interaction data. The inferencing stack can predict or estimate user representations by applying the trained model on the sparse part of the data to generate user embeddings in a same latent space.

In some embodiments, the disclosed SDLA can well capture non-linear functions or relationships between users and items. Most processes in e-commerce and in nature are very complex, because there are always some hidden variables that cannot be known or observed in advance but have a great impact on the output of the process. These unknown variables are introducing noise to the data and making the problem highly complex to involve non-learning functions. As such, instead of merely using matrix multiplications in the neural networks, the disclosed SDLA includes some non-linear functions on top of linear transformations, e.g. by feeding the weighted-input product to a sigmoid like a rectified linear unit, to create non-linear decision boundaries in order to fit and generalize the model at the same time.

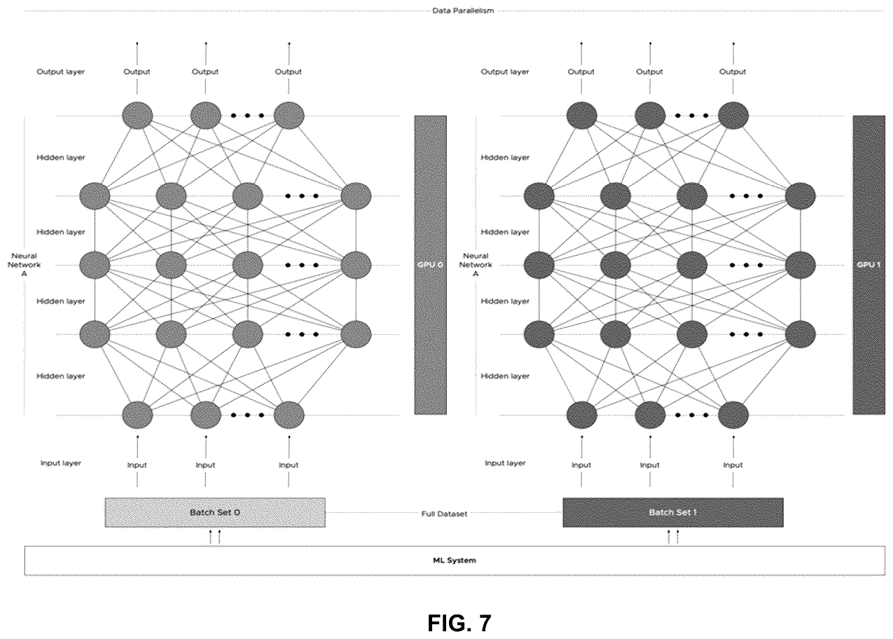

FIG. 7 illustrates an exemplary deep learning architecture utilized for generating large scale user representation, in accordance with some embodiments of the present teaching. As discussed above, the entire training dataset including sparse matrices can be split into data batches including, e.g. Batch Set 0, Batch Set 1, etc. For parallel data processing, these batches are sent to different processers, e.g. GPUs, that can run in parallel the deep learning model. As shown in FIG. 7, the Batch Set 0 is sent to GPU 0 for running the deep learning model; while the Batch Set 1 is sent to GPU 1 for running the deep learning model. Each GPU will load a full replica of the deep learning model and run the respective data batch through the model. As shown in FIG. 7, the same deep learning model with a same neural network structure is used on different GPUs, and on different data batches, which can help minimizing the inference time tremendously. For example, 10 parallel running GPUs can speed up the inference time by about 10 times.

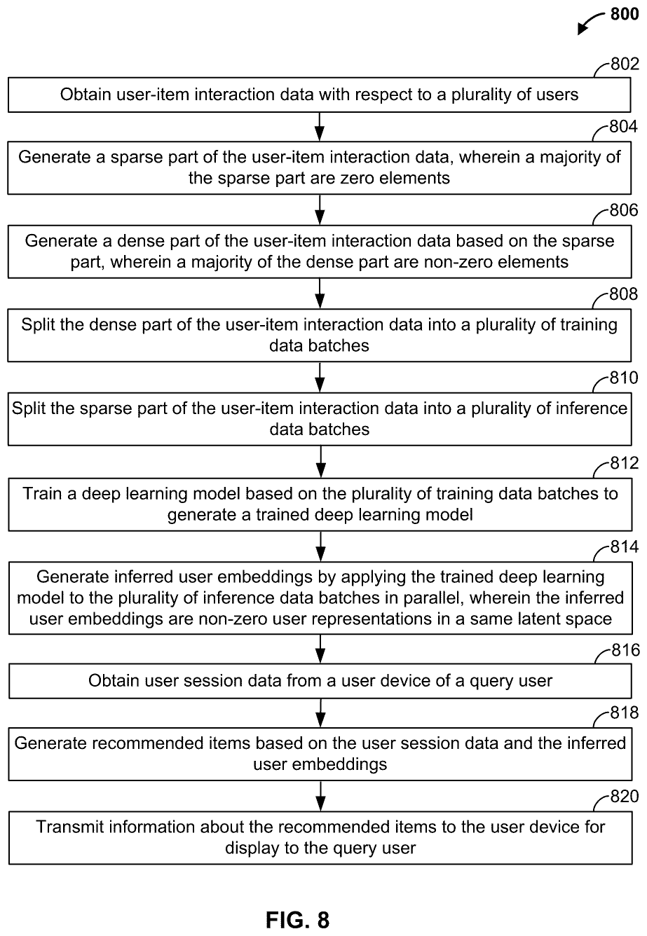

FIG. 8 is a flowchart illustrating an exemplary method 800 for providing item recommendations based on enhanced user representations, in accordance with some embodiments of the present teaching. In some embodiments, the method 800 can be carried out by one or more computing devices, such as the item recommendation computing device 102 and/or the cloud-based engine 121 of FIG. 1. Beginning at operation 802, user-item interaction data with respect to a plurality of users is obtained. At operation 804, a sparse part of the user-item interaction data is generated, where a majority of the sparse part are zero elements. At operation 806, a dense part of the user-item interaction data is generated based on the sparse part, where a majority of the dense part are non-zero elements. At operation 808, the dense part of the user-item interaction data is split into a plurality of training data batches. At operation 810, the sparse part of the user-item interaction data is split into a plurality of inference data batches.

A deep learning model is trained at operation 812 based on the plurality of training data batches to generate a trained deep learning model. At operation 814, inferred user embeddings are generated by applying the trained deep learning model to the plurality of inference data batches in parallel, where the inferred user embeddings are non-zero user representations in a same latent space. At operation 816, user session data is obtained from a user device of a query user. Recommended items are generated at operation 818 based on the user session data and the inferred user embeddings. At operation 820, information about the recommended items is transmitted to the user device for display to the query user.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMS, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database; and
at least one processor operatively coupled to the database, and configured to:
obtain user-item interaction data with respect to a plurality of users,
generate inferred user embeddings by applying a deep learning model to a plurality of inference data batches in parallel, wherein the inferred user embeddings are user representations in a same latent space,
obtain user session data from a user device of a query user,
generate recommended items based on the user session data and the inferred user embeddings, wherein:
the plurality of inference data batches are generated based on a sparse part of the user-item interaction data, a majority of the sparse part being zero elements, and
the deep learning model is trained using a plurality of training data batches generated based on a dense part of the user-item interaction data, a majority of the dense part being non-zero elements, and
transmit information about the recommended items to the user device for display to the query user.

2. The system of claim 1, wherein the at least one processor is further configured to:
obtain historical user session data and historical user transaction data of the plurality of users;
generate the user-item interaction data by parsing the historical user session data and the historical user transaction data; and
store the user-item interaction data in the database.

3. The system of claim 2, wherein:
the user-item interaction data includes a user-item interaction matrix;
each element in the user-item interaction matrix is either one representing a corresponding user had an interaction with a corresponding item, or zero representing a corresponding user had no interaction with a corresponding item; and
a majority of the elements in the user-item interaction matrix are zero.

4. The system of claim 1, wherein the at least one processor is further configured to:
generate training indexes with respect to the plurality of training data batches;
generate inference indexes with respect to the plurality of inference data batches; and
store the plurality of training data batches, the training indexes, the plurality of inference data batches, and the inference indexes into the database.

5. The system of claim 4, wherein:
the deep learning model is trained based on the plurality of training data batches and the training indexes to generate a plurality of model weights; and
the plurality of model weights are stored in the database.

6. The system of claim 5, wherein:
the at least one processor comprises a plurality of processors each of which corresponds to a respective inference data batch of the plurality of inference data batches according to the inference indexes; and
each of the plurality of processors is configured to generate inferred user embeddings by applying a full replica of the deep learning model with the plurality of model weights to the respective inference data batch.

7. The system of claim 1, wherein the at least one processor is further configured to:
train a downstream machine learning model based on the user-item interaction data and the inferred user embeddings;
generate a ranked list of the recommended items based on the user session data and the trained downstream machine learning model; and
transmit the ranked list of the recommended items to the user device to be displayed to the query user.

8. A computer-implemented method, comprising:
obtaining user-item interaction data with respect to a plurality of users;
generating inferred user embeddings by applying a deep learning model to a plurality of inference data batches in parallel, wherein the inferred user embeddings are user representations in a same latent space;
obtaining user session data from a user device of a query user;
generating recommended items based on the user session data and the inferred user embeddings, wherein:
the plurality of inference data batches are generated based on a sparse part of the user-item interaction data, a majority of the sparse part being zero elements, and
the deep learning model is trained using a plurality of training data batches generated based on a dense part of the user-item interaction data, a majority of the dense part being non-zero elements; and
transmitting information about the recommended items to the user device for display to the query user.

9. The computer-implemented method of claim 8, further comprising:
obtaining historical user session data and historical user transaction data of the plurality of users;
generating the user-item interaction data by parsing the historical user session data and the historical user transaction data; and
storing the user-item interaction data in a database.

10. The computer-implemented method of claim 9, wherein:
the user-item interaction data includes a user-item interaction matrix;
each element in the user-item interaction matrix is either one representing a corresponding user had an interaction with a corresponding item, or zero representing a corresponding user had no interaction with a corresponding item; and
a majority of the elements in the user-item interaction matrix are zero.

11. The computer-implemented method of claim 8, further comprising:
generating training indexes with respect to the plurality of training data batches;
generating inference indexes with respect to the plurality of inference data batches; and
storing the plurality of training data batches, the training indexes, the plurality of inference data batches, and the inference indexes into a database.

12. The computer-implemented method of claim 11, wherein:
the deep learning model is trained based on the plurality of training data batches and the training indexes to generate a plurality of model weights; and
the plurality of model weights are stored in the database.

13. The computer-implemented method of claim 12, wherein:
each respective inference data batch of the plurality of inference data batches corresponds to a respective one of a plurality of processors according to the inference indexes; and
each of the plurality of processors is configured to generate inferred user embeddings by applying a full replica of the deep learning model with the plurality of model weights to the respective inference data batch.

14. The computer-implemented method of claim 8, further comprising:
training a downstream machine learning model based on the user-item interaction data and the inferred user embeddings;
generating a ranked list of the recommended items based on the user session data and the trained downstream machine learning model; and
transmitting the ranked list of the recommended items to the user device to be displayed to the query user.

15. A non-transitory computer readable medium having instructions stored thereon, wherein the instructions, when executed by at least one processor, cause at least one device to perform operations comprising:
obtaining user-item interaction data with respect to a plurality of users;
generating inferred user embeddings by applying a deep learning model to a plurality of inference data batches in parallel, wherein the inferred user embeddings are user representations in a same latent space;
obtaining user session data from a user device of a query user;
generating recommended items based on the user session data and the inferred user embeddings, wherein:
the plurality of inference data batches are generated based on a sparse part of the user-item interaction data, a majority of the sparse part being zero elements, and
the deep learning model is trained using a plurality of training data batches generated based on a dense part of the user-item interaction data, a majority of the dense part being non-zero elements; and
transmitting information about the recommended items to the user device for display to the query user.

16. The non-transitory computer readable medium of claim 15, wherein the instructions, when executed by the at least one processor, cause the at least one device to further perform operations comprising:
obtaining historical user session data and historical user transaction data of the plurality of users;
generating the user-item interaction data by parsing the historical user session data and the historical user transaction data; and
storing the user-item interaction data in a database.

17. The non-transitory computer readable medium of claim 16, wherein:
the user-item interaction data includes a user-item interaction matrix;
each element in the user-item interaction matrix is either one representing a corresponding user had an interaction with a corresponding item, or zero representing a corresponding user had no interaction with a corresponding item; and
a majority of the elements in the user-item interaction matrix are zero.

18. The non-transitory computer readable medium of claim 15, wherein the instructions, when executed by the at least one processor, cause the at least one device to further perform operations comprising:
generating training indexes with respect to the plurality of training data batches;
generating inference indexes with respect to the plurality of inference data batches; and
storing the plurality of training data batches, the training indexes, the plurality of inference data batches, and the inference indexes into a database.

19. The non-transitory computer readable medium of claim 18, wherein:
the deep learning model is trained based on the plurality of training data batches and the training indexes to generate a plurality of model weights;
the plurality of model weights are stored in the database;
the at least one device comprises a plurality of computing devices each of which corresponds to a respective inference data batch of the plurality of inference data batches according to the inference indexes; and
each of the plurality of computing devices is configured to generate inferred user embeddings by applying a full replica of the deep learning model with the plurality of model weights to the respective inference data batch.

20. The non-transitory computer readable medium of claim 15, wherein the instructions, when executed by the at least one processor, cause the at least one device to further perform operations comprising:
training a downstream machine learning model based on the user-item interaction data and the inferred user embeddings;
generating a ranked list of the recommended items based on the user session data and the trained downstream machine learning model; and
transmitting the ranked list of the recommended items to the user device to be displayed to the query user.
